(19) United States
(12) Patent Application Publication
(10) Pub. No.: US 2023/0359032 A1
(43) Pub. Date: Nov. 9, 2023

(54) OPTICAL DISPLAY SYSTEM

(71) Applicant: National Yang Ming Chiao Tung University, Hsinchu City (TW)

(72) Inventors: Yi-Hsin LIN, Zhubei City (TW); Chang-Nien MAO, New Taipei City (TW); Wei-Cheng CHENG, Zhudong Township (TW)

(21) Appl. No.: 17/871,264

(22) Filed: Jul. 22, 2022

(30) Foreign Application Priority Data
May 6, 2022 (TW) 111117211

(51) Int. Cl. G02B 27/01; G02B 27/00

(52) U.S. Cl. CPC G02B 27/0172; G02B 27/0075

(57) ABSTRACT

An optical display system includes an augmented reality device and a lens device. The augmented reality device has an output surface which is disposed to permit a combined image from the augmented reality device to be direct to an eye of a viewer. The lens device is disposed between the output surface and the eye of the viewer, and includes a focus lens unit and a variable focus lens. The focus lens unit is disposed proximate to the output surface, and is configured to shift a focus of a combined light contributed to the combined image. The variable focus lens is disposed distal from the output surface, and is configured to continuously shift the focus of the combined light that is being focused by the focus lens unit.

### CROSS-REFERENCE TO RELATED APPLICATION

This application claims priority of Taiwanese Invention Patent Application No. 111117211, filed on May 6, 2022.

### FIELD

The disclosure relates to an optical display system, and more particularly to an optical display system with a wider adjustable range of optical power.

### BACKGROUND

A near-eye display for an augmented reality (AR) system or the like is used to create a combined image of a virtual image and a real image in the field of view (FOV) for both eyes of a viewer. To give the viewer an improved FOV, a distance between the near-eye display and each of the eyes is normally kept at a limited range, for example, about 15 mm to 20 mm. However, the eyes of a viewer wearing eyeglasses might not be kept in the aforesaid distance range, which might adversely affect the FOV. In addition, it is cumbersome if the eyeglasses are necessary to be provided between the user and the near-eye display for viewing images.

### SUMMARY

Therefore, an object of the disclosure is to provide an optical display system with a wider adjustable range of optical power.

According to the disclosure, an optical display system includes an augmented reality device and a lens device. The augmented reality device has an output surface which is disposed to permit a combined image from the augmented reality device to be directed to an eye of a viewer. The lens device is disposed between the output surface and the eye of the viewer, and includes a focus lens unit and a variable focus lens. The focus lens unit is disposed proximate to the output surface, and is configured to shift a focus of a combined light that results in the combined image. The variable focus lens is disposed distal from the output surface, and is configured to continuously shift the focus of the combined light that is being focused by the focus lens unit.

### BRIEF DESCRIPTION OF THE DRAWINGS

Other features and advantages of the disclosure will become apparent in the following detailed description of the embodiment(s) with reference to the accompanying drawings, in which:

FIG. 1 is a schematic view illustrating an optical display system in accordance with a first embodiment of the disclosure;

FIG. 2 is a schematic view illustrating an optical display system in accordance with a second embodiment of the disclosure;

FIG. 3 is a schematic view illustrating an optical display system in accordance with a third embodiment of the disclosure; and

FIG. 4 is a schematic view illustrating an optical display system in accordance with a fourth embodiment of the disclosure.

### DETAILED DESCRIPTION

Before the disclosure is described in greater detail, it should be noted that where considered appropriate, reference numerals have been repeated among the figures to indicate corresponding or analogous elements, which may optionally have similar characteristics.

It should be also noted that the drawings, which are for illustrative purposes only, are not drawn to scale, and are not intended to represent the actual sizes or actual relative sizes of the components of a pancake lens assembly.

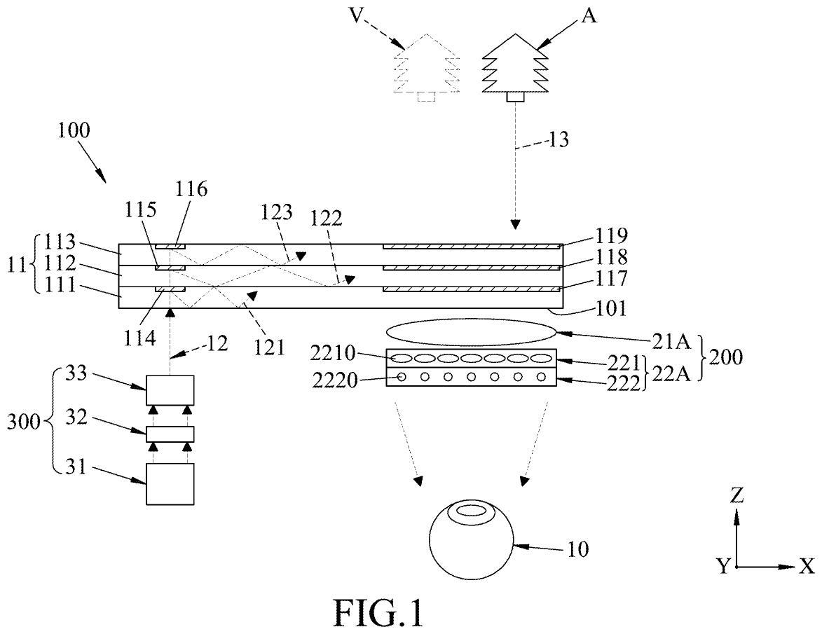

Referring to FIG. 1, an optical display system in accordance with a first embodiment of the disclosure is shown to include an augmented reality device 100 and a lens device 200.

The augmented reality device 100 has an output surface 101 which is disposed to permit a combined image from the augmented reality device 100 to be directed to an eye 10 of a viewer (not shown).

In some embodiments, the augmented reality device 100 includes a waveguide unit 11 having the output surface 101 and configured to permit a first light 12 for forming a virtual image (V) and a second light 13 from an object (A) in a real world to combine and output from the output surface 101, thereby forming a combined image.

The waveguide unit 11 may include at least one waveguide. In some embodiments as illustrated in FIG. 1, the waveguide unit 11 includes three waveguides 111, 112, 113 for guiding three portions 121, 122, 123 of the first light 12. Each of the waveguides 111, 112, 113 includes an in-coupling region 114, 115, 116 and an out-coupling region 117, 118, 119.

The in-coupling region 114, 115, 116 is configured to deflect a corresponding portion 121, 122, 123 of the first light 12 from a light-providing device 300 to propagate in the corresponding waveguide 111, 112, 113. In some embodiments, the light-providing device 300 may include a light source 31, a light modulator 32 (e.g., a display) for modulating a light from the light source 31, and projection lenses 33 for injecting the light from the light modulator 32 into the waveguide unit 11. The light outputted from the projection lenses 33 may serve as the first light 12.

The out-coupling region 117, 118, 119 is configured to direct the corresponding portion 121, 122, 123 of the first light 12 propagating in the corresponding waveguide 111, 112, 113 toward the eye 10 of the viewer through the output surface 101 when the corresponding portion 121, 122, 123 of the first light 12 propagating in the corresponding waveguide 121, 122, 123 impinges the out-coupling region 117, 118, 119.

Other suitable augmented reality devices are also within the contemplated scope of the disclosure.

The lens device 200 is disposed between the output surface 101 and the eye 10 of the viewer, and includes a focus lens unit 21A and a variable focus lens 22A.

The focus lens unit 21A is disposed proximate to the output surface 100, and is configured to shift a focus of a combined light which results in the combined image. In some embodiments, the focus lens unit 21A is a fixed focus lens, such as a solid lens, a concave lens, a plano-concave lens, a convex lens, a plano-convex lens, a freeform optical lens, or other suitable optical lens. In some embodiments as shown in FIG. 1, the focus lens unit 21A is a polarization-independent lens.

The variable focus lens 22A is disposed distal from the output surface 101, and is configured to continuously shift the focus of the combined light that is being focused by the focus lens unit 21A. In some embodiments, the variable focus lens 22A is an electrically tunable focusing liquid crystal lens. In some embodiments, the variable focus lens 22A is a polarization-independent lens and includes a first lens 221 and a second lens 222. The combined light is introduced into the lens device 200 in a Z direction (see FIG. 1). In the first lens 221, long axes of first liquid crystal molecules 2210 are orientated on an XZ plane which is defined by an X direction and the Z direction shown in FIG. 1. The second lens 222 has a plurality of second liquid crystal molecules 2220, and long axes of the second liquid crystal molecules 2220 are orientated on an YZ plane which is defined by a Y direction and the Z direction shown in FIG. 1. The orientation direction of the first liquid crystal molecules 2210 is substantially perpendicular to that of the second liquid crystal molecules 2220. In some embodiments, the variable focus lens 22A has a limited adjustable range of the optical power, for example, from −2D to +2D. Therefore, in the case that the lens device 200 only includes the variable focus lens 22A, the optical display system may be for people who wear vision correction lenses with a diopter ranging from −2D to +2D, for example.

By combining the focus lens unit 21A having an optical power of −6D, for example, with the variable focus lens 22A such as one having an adjustable optical power ranging from −2D to +2D, the optical display system may be for people who, for example, wear vision correction lenses with a diopter ranging from −8D to −4D.

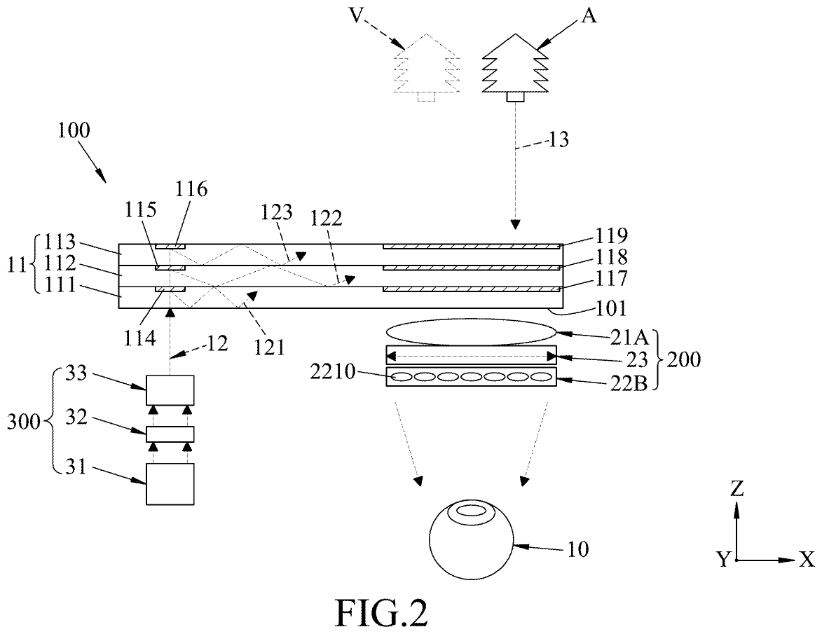

FIG. 2 illustrates an optical display system in accordance with a second embodiment of the disclosure. The second embodiment is similar to the first embodiment except that in the second embodiment, a variable focus lens 22B is a polarization-dependent lens, and the lens device 200 further includes a polarizer 23 disposed upstream of the variable focus lens 22B so as to permit a combined light that is being focused by the focus lens unit 21A and polarized by the polarizer 23 to pass through the variable focus lens 22B. In some embodiments, the variable focus lens 22B may include the first liquid crystal molecules 2210. In some embodiments, the variable focus lens 22B is an electrically tunable focusing liquid crystal lens. Although the polarizer 23 in FIG. 2 is disposed between the focus lens unit 21A and the variable focus lens 22, the polarizer 23 in an alternative embodiment may be disposed between the output surface 101 and the focus lens unit 21A.

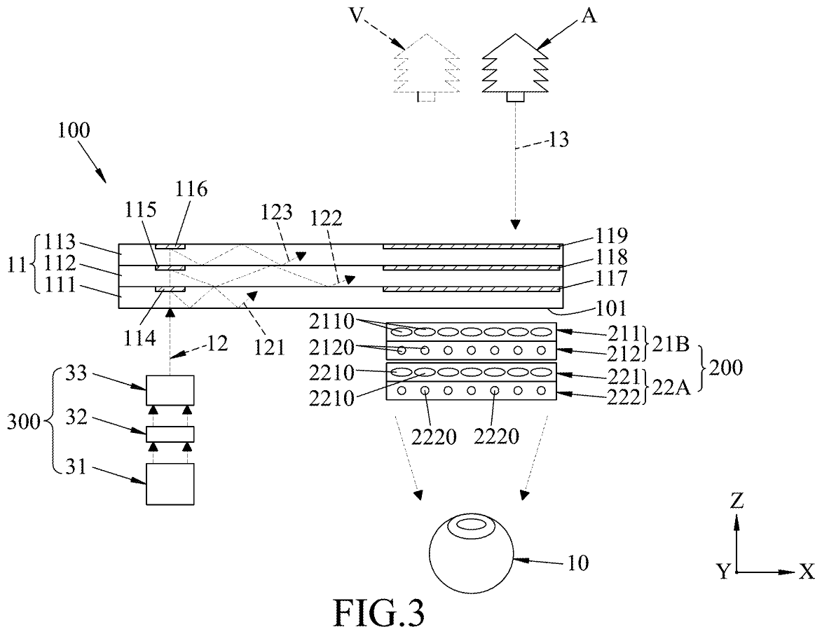

FIG. 3 illustrates an optical display system in accordance with a third embodiment of the disclosure. The third embodiment is similar to the first embodiment except that in the third embodiment, the focus lens unit 21B is a polarization-independent liquid crystal lens that provides a fixed focus and includes two lenses 211, 212. In the liquid crystal lens 211, liquid crystal molecules 2110 are orientated in the X direction, and in the liquid crystal lens 212, liquid crystal molecules 2120 are orientated in the Y direction. In some embodiments as shown in FIG. 3, the two liquid crystal lenses 211, 212 are disposed proximate to and distal from the output surface 101 of the lens device 200, respectively. In other embodiments not shown, positions of the liquid crystal lenses 211, 212 may be switched (i.e., the two liquid crystal lenses 211, 212 are disposed distal from and proximate to the output surface 101 of the lens device 200, respectively).

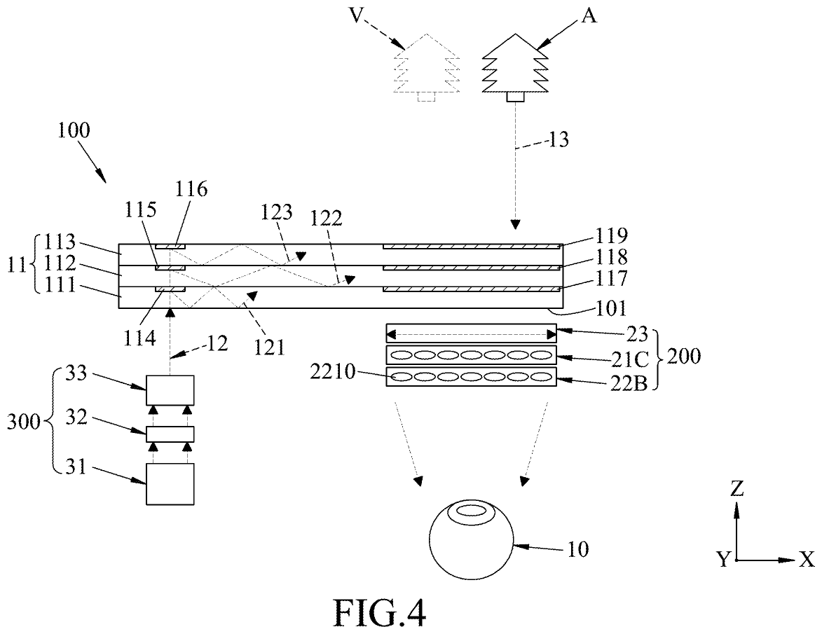

FIG. 4 illustrates an optical display system in accordance with a fourth embodiment of the disclosure. The fourth embodiment is similar to the second embodiment except that in the fourth embodiment, a focus lens unit 21C is a polarization-dependent lens that provides a fixed focus, and the polarizer 23 is disposed upstream of the focus lens unit 21C and the variable focus lens 22B.

Using the optical display system equipped with the lens device 200, the viewer may directly view the combined image from the augmented reality device 100 without having to wear eyeglasses or the like for vision correction.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An optical display system comprising:
an augmented reality device having an output surface which is disposed to permit a combined image from, said augmented reality device to be directed to an eye of a viewer; and
a lens device disposed between said output surface and the eye of the viewer, and including
a focus lens unit disposed proximate to said output surface, and configured to shift a focus of a combined light that results in the combined image, and
a variable focus lens disposed distal from said output surface, and configured to continuously shift the focus of the combined light that is being focused by said focus lens unit.

2. The optical display system of claim 1, wherein said focus lens unit is a fixed focus lens.

3. The optical display system of claim 2, wherein said focus lens unit is a polarization-independent lens.

4. The optical display system of claim 1, wherein said variable focus lens is an electrically tunable focusing liquid crystal lens.

5. The optical display system of claim 1, wherein said variable focus lens is a polarization-independent lens.

6. The optical display system of claim 1, wherein said variable focus lens is a polarization-dependent lens, and said lens device further includes a polarizer disposed upstream of said variable focus lens.

7. The optical display system of claim 1, wherein each of said focus lens unit and said variable focus lens is a polarization-independent liquid crystal lens.

8. The optical display system of claim 1, wherein each of said focus lens unit and said variable focus lens is a polarization-dependent lens, and said lens device further includes a polarizer disposed upstream of said focus lens unit and said variable focus lens.

9. The optical display system of claim 1, wherein said augmented reality device includes a waveguide unit which has said output surface and which is configured to permit a first light for forming a virtual image and a second light from an object in a real world to combine and output from said output surface, thereby forming the combined image.

10. The optical display system of claim 9, wherein said waveguide unit includes at least one waveguide which has
an in-coupling region configured to deflect the first light from a light-providing device to propagate in said waveguide, and
an out-coupling region configured to direct the first light propagating in said waveguide toward the eye of the viewer through said output surface when the first light propagating in said waveguide impinges said out-coupling region.
